(19) United States
(12) Patent Application Publication
(10) Pub. No.: US 2003/0117953 A1
(43) Pub. Date: Jun. 26, 2003

(54) Method, system, and apparatus for pre-allocation of call channels

(76) Inventors: Michael M. Kinahan, Calgary (CA); Jason B. Spotswood, Calgary (CA); Trevor J. Hicks, Kanata (CA); Michael Leibovitch, Ottawa (CA); Dominic Peluso, Kanata (CA)

Correspondence Address: D. Doak Horne, Gowling Lafleur Henderson LLP, Suite 1400, 700 2nd Street S.W., Calgary, AB, T2P 4V5, CA

(21) Appl. No.: 10/022,529

(22) Filed: Dec. 20, 2001

(51) Int. Cl. H04L 1/00

(52) U.S. Cl. 370/229; 370/437

(57) ABSTRACT

A method, system, and apparatus are disclosed for reducing set-up time for calls by pre-allocating channels in communication networks. The present invention is based on doing as much of the set-up work as possible before communication resources are actually needed, and then, after resources are needed, using a fast way of executing that work which could not be completed until after the resources were needed. An embodiment of the present invention deploys a first agent to proactively manage communication resources configuring and reserving channels for a principal required to report to a network the address of a suitable supplementary channel available through a second agent. Allocating channels in advance permits fast, consistent, and predictable service times in response to requests for data-burst service. All embodiments of the present invention address a pressing need of service providers who must set-up data-burst sessions very quickly to permit applications to run faster across networks.

### FIELD OF THE INVENTION

The present invention relates in general to the more efficient use of resources in communication systems and, in particular, to methods, systems and apparatus for supplying data channel access to Customers using wireless communication networks.

### BACKGROUND OF THE INVENTION

Whenever Customers need to move data over a network, especially if the service is to simulate “real-time” processing, the most effective way to provide the required service is to dedicate a particular channel to the task and send the data stream as a high-speed burst (or bursts). A “channel” in the communication sense is a logical concept that involves configuring transmission and reception equipment (e.g. an ASIC modem) associated with a single physical resource (e.g. a wire line, optical fibre, antenna) that may be used for different forms of signalling. The same type of physical resource can therefore also operate at different capacities depending on how it is configured as a channel. A “1×” channel is configured to transfer data at 1 times the “base rate” for the scheme implemented. A “2×” channel is configured to operate transferring data at 2 times the “base rate” of the scheme, resulting in a higher capacity for that channel. However, a single 2× channel typically requires 2 times the physical resources of a channel configured for 1×. Further, since not all channel configurations are suited to delivering “data services” there is a need to identify at least one channel suited to each task of each Customer before assigning a “call” to a channel. Physical (channel) resources may also be shared by different signals multiplexed in different ways including CDMA (code division multiplexing), an encoding scheme in which the transmitter encodes using one of several random sequences that it shares with the receiver—and under which each unique random bit sequence corresponds to a different (logical) “channel”. Finally, a limited number of channels suited to data transfer are available, such that all such channels are normally either busy or in the process of switching between data streams that are buffered awaiting access to the channels required.

Conventional methods of channel assignment are carried out by network elements that communicate with the controller for a single Base-station Transceiver Subsystem (“BTS”), i.e. the Base-station Transceiver Subsystem Controller (“BTSC”) or its Call Resource Manager (“CRM”), communicating with external Channel Element Modules (“CEMs”)—after channels are first actually required by the Customer—to identify at least one CEM that can handle each high-speed Supplementary Channel (“SCH”) request. Depending on the implementation of the particular network this may involve a series of asynchronous command and response exchanges between the BTSC and a number of CEMs. Only after an appropriate CEM has been identified is a Resource Allocation Command (“RAC”) first sent to that CEM. The BTSC then waits to receive an asynchonous response before assigning the (now reserved) channel to the Customer call. Conventional methods have low overhead in terms of memory because there is no or limited storage of the information (class, location, status) needed to characterize and uniquely identify available channel resources. However, the problem is in part that “off board” communications are much slower than the BTSC's “on board” data bus.

Conventional data-burst channel “call set-up” follows the sequence:

1) Customer initiates an unscheduled call for resources to send or receive a significant stream of data across a portion of the network

2) Network elements communicative with the BTSC classify the call (in terms of type, capacity, and other factors)

3) BTSC queries to identify at least one available “off board” CEM that has appropriate channels available to fulfill an allocation command from the BTSC

4) CEMs process query from BTSC and respond via an “off board” communication link

5) BTSC processes responses and sends allocation command to one CEM

6) Selected CEM processes command and confirms channel allocation to BTSC, and

7) Network elements communicative with the BTSC assign the Customer's “call” to the allocated channel.

The problem with traditional designs is in two parts. First the designs wait until the service is needed before finding the capacity. Second, after the service is needed, the designs complete slow “off board” exchanges in order to locate the required capacity. A long set-up time results. Wireless systems must now deliver large amounts of data in the form of pictures, graphics, video, in addition to voice—direct to mobile users. To date the solution to the delay problem has been to increase infrastructure and network power—making more physical resources available and using higher speed components in the BTSC as well as in the external units with which it communicates, thereby reducing the “call set-up” time consumed by the large number of individual exchanges. As the volume of data traffic increases, the risk of transmission delays resulting in loss of Customers also increases, such that a more efficient solution is also required.

### SUMMARY OF THE INVENTION

The present inventive solution to the problem is also in two parts. First, do as much of the work as possible before the resources are actually needed. Second, after the service is needed, use a higher speed connection to execute that work which could not be completed until after the resources were needed. The availability of larger numbers of higher capacity resources has resulted in a situation in which channels are periodically idle—creating an opportunity to manage all channels in a better way by reserving some channels to particular uses. Rearranging the work and “on board” communications together lead to shorter apparent call “set-up” time and facilitate better “real-time” processing.

The disclosed invention solves problems with known technologies by eliminating both the reactive nature of the traditional method and the slow off-board communication of the BTSC (or its CRM) with CEMs after the call arrives. There are three aspects of the present invention, which encompasses a method, a system and an apparatus for reducing the set-up time for calls by organizing communication channels into reserved “pools” in preparation to be deployed very quickly to fulfill allocation commands. The reduced apparent time required for “call set-up” in wireless communication networks is important to mobile Customers of data services, since channels are made available to Customers a shorter time after they are requested. An agent (the Channel Resource Pool “CRP” module) of the BTSC proactively identifies resources that will eventually be required when it pre-determines information (class, location, status) about the resources to which it has access and reserves them to pools from which it may assign directly when a Customer initiates a call for “data burst” services. The resequenced task of communication (with CEMs) is also delegated from the BTSC to the CRP, freeing up the BTSC and completing part of the communication task before the results are required, thereby decreasing “set-up time” and increasing the data throughput of the system. Rather than buffering and scheduling calls, the present invention permits network operators to pre-configure, pre-classify, and pre-allocate otherwise idle resources to fulfill random calls for data service, resulting in a shorter actual delay between the demand for and the supply of those resources.

In accordance with an aspect of the present invention there is provided a method for reducing set-up time for calls in a network, the method comprising: pre-allocating some configured channels to be available for calls; receiving at least one command, including information, to provide at least one configured channel for a call; and assigning, based on said information, at least one pre-allocated configured channel in response to said at least one command.

In accordance with an aspect of the present invention there is further provided a method for reducing set-up time for calls in a network supporting both data and voice type calls, the method comprising: pre-allocating some configured channels to be available for data calls and pre-allocating some said channels to be available for voice calls; receiving at least one command, including information, to provide at least one configured channel for either a voice or a data call; and assigning, based on said information, at least one pre-allocated configured channel in response to said at least one command.

In accordance with an aspect of the present invention there is further provided a method for reducing set-up time for calls, comprising: configuring at least one channel for calls; reserving said at least one configured channel and storing information relating to said at least one configured channel; receiving at least one command, including information, to allocate a channel to a call, and thereafter selecting a configured channel the stored information for which matches said information included in said command; and assigning at least one configured channel to each said call.

In accordance with an aspect of the present invention there is provided a system for reducing set-up time for a call, comprising: a first agent for configuring and reserving at least one channel; a second agent for supplying communication resources including said configured and reserved channels in response to a communication from said first agent, said first agent also being communicative with a principal; and said principal adapted to acquire access to configured channels for the call by sending a resource allocation command to said first agent to allocate one of said at least one configured and reserved channel to the call.

In accordance with an aspect of the present invention there is provided an apparatus being a first agent for a system for reducing set-up time for calls, comprising: a module for configuring at least one channel for calls; a module for reserving and tracking all said configured channels; a module for receiving at least one command to allocate a channel to a call; a module for matching each said command to a configured channel; and a module for allocating a separate configured channel to each said call.

The accompanying drawings, which are incorporated in and constitute a part of this specification, illustrate embodiments of the method, system, and apparatus according to the invention and, together with the description, serve to explain the principles of the invention.

### BRIEF DESCRIPTION OF THE DRAWINGS

The present invention, in order to be easily understood and practised, is set out in the following non-limiting examples shown in the accompanying drawings, in which:

FIG. 1 is an illustration of a preferred embodiment of the method of the present invention;

FIG. 2 is an illustration of one embodiment of the system of the present invention;

FIG. 3 is an illustration of one embodiment of the apparatus (being a more detailed breakdown that includes modules of first agent 130) of the present invention;

FIG. 4 is an illustration of a broad embodiment of the method of the present invention; and

FIG. 5 is an illustration of a still broader embodiment of the method of the present invention.

### DETAILED DESCRIPTION OF THE PREFERRED EMBODIMENT

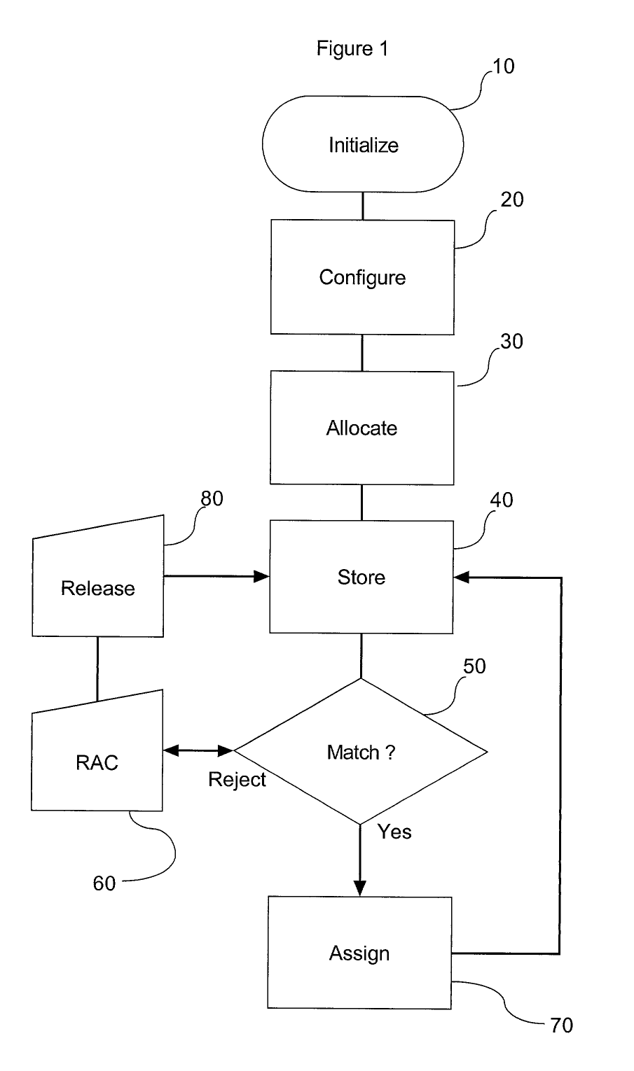

Reference is to be had to FIGS. 1-5, in which identical reference numbers identify similar items.

To overcome the disadvantages of the known technologies including delays while identifying and assigning channels configured for data to service incoming requests from wireless Customer devices, an embodiment of the present invention deploys CRP software as first agent 130 to proactively manage communication resources configuring and reserving channels for the BTSC as principal 120 required to report to a network 110 the address of a suitable SCH 150 available through a CEM bank as second agent 140. Allocating channels in advance permits fast, consistent, and predictable service times in response to requests for data-burst service, all of which are important to wireless service providers offering powerful data applications to attract new Customers. All embodiments of the present invention address a pressing need of service providers (especially Application Service Providers or “ASPs”), who must set-up data-burst sessions very quickly since the growing demand from their Customers is for quick responses to permit applications to run faster across networks.

Operation of an embodiment of the present invention will now be described with reference to FIGS. 1-5.

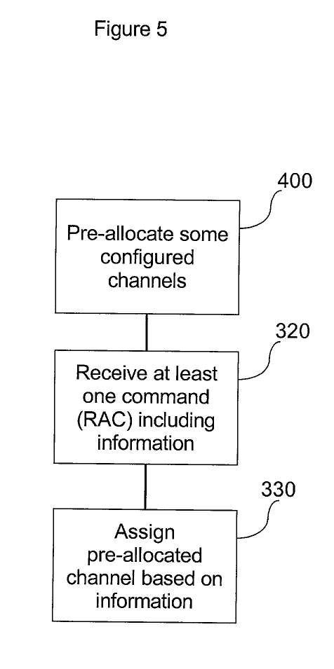

In one of its broadest embodiments, as illustrated in FIG. 5 according to the method aspect of the present invention some configured channels are allocated for calls 400, after which there is received at least one command 320, in the form of a RAC, to provide service for a call. The command includes information (e.g. but is not limited to: class, location, and status) about the services being requested, based on which information at least one pre-allocated channel is assigned 330 to service the call.

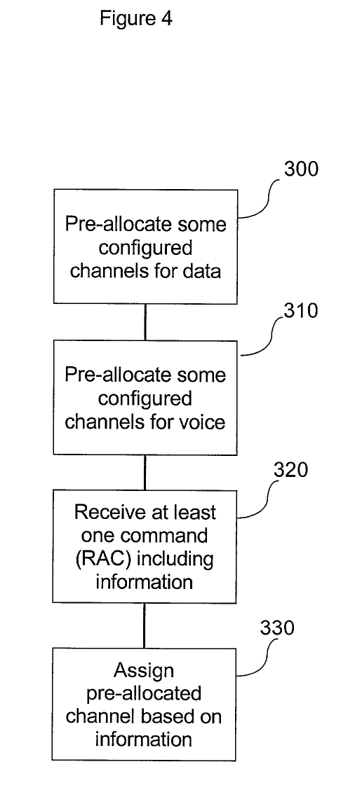

In another of its broad embodiments, as illustrated in FIG. 4 according to the method aspect of the present invention some configured channels are allocated for data calls 300 and some configured channels are allocated for voice calls 310, after which a command is received 320, in the form of a RAC, to provide service for either a voice or a data call. Similarly in this embodiment the command includes information (e.g. but is not limited to: class, location, and status—with class including the call “type” being voice or data) about the services being requested, based on which information at least one pre-allocated channel is assigned 330 to service the call.

In a preferred embodiment, as illustrated in FIG. 1, the method aspect of the present invention provides an initialization step 10 wherein the physical communication resources accessible have been queried and split to define a suitable distribution of the then possible logical channels as well as the particular channels to be deployed. Configuration 20 implements the distribution of (physical) resources into (logical) channels according to initialization 10. Allocation 30 defines target levels for the portion of configured channels to be reserved. Storage 40 enters information into a database respecting the configured channels that have been allocated thereby creating a list from which said configured and reserved channels may be assigned without further processing delay. Inherent in the use of a database, to which said information is added, is the ability to track configured and reserved channels as well as toggle the status field in the database record of each such channel between active and idle as appropriate. Matching 50 compares the information input with each Resource Allocation Command (“RAC”) 60 to the information in said database as each said RAC 60 is received. If during matching 50 at least one exact match is detected, then the first exactly matching channel is immediately assigned 70 to the call, RAC 60 fulfillment confirmation is made, and the database of 40 is updated toggling the status field of said assigned channel to active. If no configured and reserved channel with exactly matching information is identified in the database, then the call is either “upgraded or downgraded” to use the configured and reserved channel that most closely matches the information input with RAC 60 and said most closely matching channel is immediately assigned 70 to said call. If no configured and reserved channels are available, then RAC 60 is rejected, however a person of skill in the art would understand that such rejected RACs could be queued for a limited time for later fulfillment. Similarly, a command could be sent to configure 20 more resources. Although channels may remain assigned to a call indefinitely, in normal operation each RAC 60 will be followed by a Release 80 command that will toggle the status field stored 40 in the database record of said assigned channel to idle, thereby releasing said assigned channel for assignment to other calls.

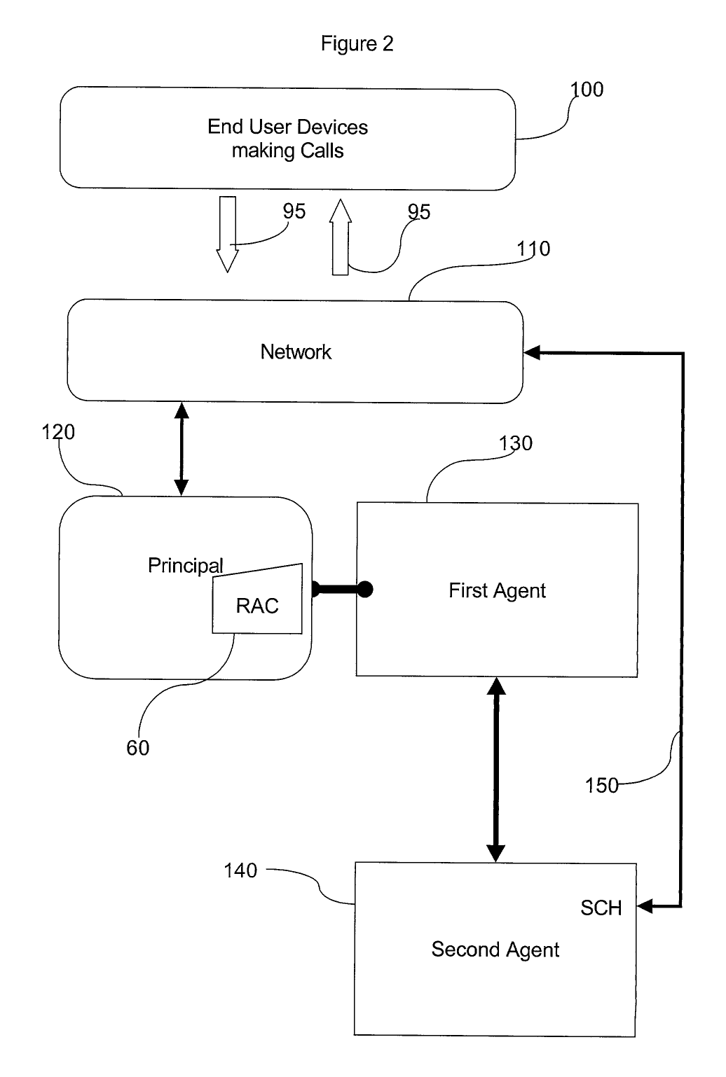

In one of its embodiments, as illustrated in FIG. 2 the system aspect of the present invention in which the method illustrated in FIG. 1 may be practiced, presumes end user devices 100 wirelessly 95 communicative with a network 110 having bilateral access to principal 120 that sends RACs 60 to first agent 130 communicative with second agent 140 that provides configured channels to network 110. Upon network 110 needing a supplementary channel (“SCH”) 150 to service an end user device 100 that makes calls, a request for the address of an appropriate channel is sent to principal 120 (typically a Base-station Transceiver Subsystem Controller “BTSC”) which issues RAC 60 to first agent 130 (typically a Channel Resource Pool “CRP”) that has previously reserved at least one configured channel available through second agent 140. Practising the invented method aspect illustrated in FIG. 1, first agent 130 matches RAC 60 to a reserved configured channel in the database of 40 and immediately provides the address of said reserved configured channel to principal 120 which reports said address to network 110 which communicates with second agent 140 delivering said call via an assigned channel represented by SCH 150. When first agent 130 so provides said address it assigns said channel by toggling the status field of the record of said assigned channel to “active” thereby updating said database of 40.

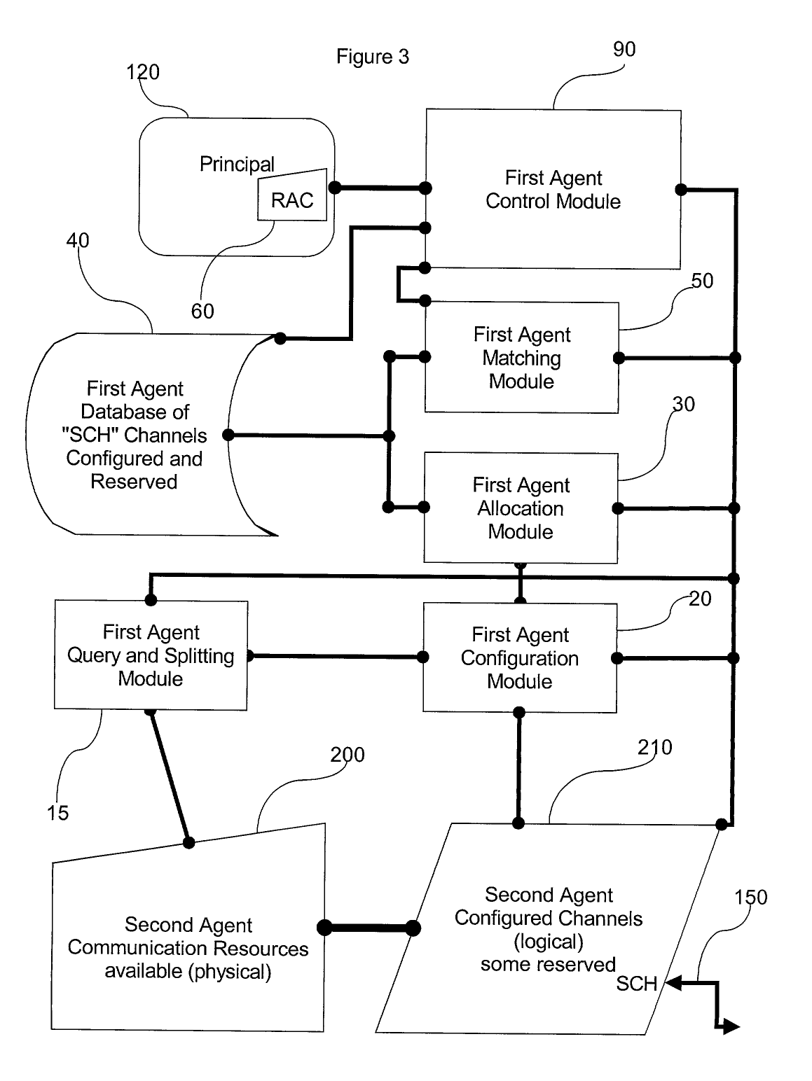

In one of its embodiments, as illustrated in FIG. 3, the apparatus aspect of the present invention includes modules of first agent 130 used in the system aspect of said invention illustrated in FIG. 2 to practice the method illustrated in FIG. 1, said apparatus aspect comprising a control module 90 that receives RACs 60 for fulfillment. At initialization 10, triggered by control module 90, query and splitting module 15 determined the physical resources 200 available (in second agent 140) and instructed configuration module 20 which logical channels (in second agent 140) to configure according to the splitting algorithm then in effect. Also triggered by control module 90, allocation module 30 communicative with configuration module 20 determines which configured channels 210 to reserve and allocates at least one said configured channel to the database of 40 as a configured and reserved channel represented by SCH 150 available for immediate assignment to a call. When RAC 60 is received from principal 120, control module 90 causes matching module 50 to identify a configured and reserved channel in the database of 40 matching the information in RAC 60. Upon matching, control module 90 immediately provides to principal 120 the address of said matching configured and reserved channel (from those 210 available through second agent 140) and assigns 70 said channel toggling the status field of said channel to “active” in the corresponding record of the database of 40—until Release command 80 is received upon which control module 90 toggles the status field of said channel to “idle” in the corresponding record of the database of 40, thereby making said channel available for matching and assignment to other calls.

Embodiments of the method aspect of the present invention have immediate application to the BTSC in any CDMA2000 capable base station, however, a person skilled in the art would understand that embodiments of said invention can be implemented in any Base-Station, including, but not limited to those supporting: GSM, TDMA, W-CDMA, and UMTS. Further it is understood that the principal, first agent, and second agent may exist at the same location or at different locations. In one embodiment of the present invention, the controller of a wireless base station (e.g. the Nortel Metro-cell™) is deployed to fill the role of principal 120 implementing CMDA-2000, which standard satisfies both voice and data requirements at high speed & capacity. In this embodiment the present invention effectively eliminates the need for call buffering by eliminating the need for the BTSC to query all CEMs such that significant time is saved and when the BTSC instructs (via RAC 60) the CRP to deliver an appropriate channel from its (database) pre-allocated pool, the CRP is normally able to respond immediately. In this embodiment, it is typically during initialization 10 of the new BTSC installation and when changes are made to the Customers' network (adding CEMs) that the installer defines the number of each type and capacity of channel that the CRP will have access to. However, in another embodiment of the present invention the operator can dynamically reconfigure the system by accessing reserve banks of CEMs and reconfigure the CEMs to deliver channels with different capacities, directions, and other programmable characteristics. Further, using CRP first agent 130 decreases the processing burden on BTSC principal 120 that was previously required to identify and allocate appropriate channels required to handle Customer demand for high-speed data-burst services. A decrease in the processing burden on the BTSC directly increases the data call processing capacity of the system in which an embodiment of the present invention is implemented. Under the current technology, each Fundamental Channel (“FCH ”) is limited to one F-SCH and one R-SCH, however nothing precludes using an embodiment of the method aspect of the present invention with technology that supports more than one forward or reverse SCH per FCH. In one embodiment of the present invention, once the total resources available to be pre-allocated have been identified by query module 15—that total is split between forward channels (of at least the 5 different capacities: 1×, 2×, 4×, 8×, and 16×) and, if reverse mode is enabled, reverse channels (also of different capacities). The splitting algorithm is designed to achieve optimal efficiency as a part of which, for example only, it splits resources in a manner that reduces the total number of F-SCHs by eliminating the smaller capacity channels. Different network scenarios apply the algorithm in different ways based on how many channel capacities are available.

First agent 130 calculates an appropriate level to which to pre-allocate each class of channel, which is calculated from a combination of configuration information including:

the frequencies of the base station that are configured for data

the number of resources available on each sector for Voice

the number of resources available on each sector for Data

the maximum percentage of resources each frequency has limited to voice calls

the maximum percentage of resources each frequency can allocate to data calls

of data resources dedicated as “Fundamental Channels”

a determination of whether the selected frequency supports high speed data bursts in the reverse direction (i.e. from wireless terminal up to the network).

the number of forward and reverse channels configured for use

the number of forward and reverse channels available for use

In accordance with an aspect of the present invention there is provided a method for reducing set-up time for calls in a network, the method comprising: pre-allocating some configured channels to be available for calls; receiving at least one command, including information, to provide at least one configured channel for a call; and assigning, based on said information, at least one pre-allocated configured channel in response to said at least one command.

In accordance with an aspect of the present invention there is further provided a method for reducing set-up time for calls in a network supporting both data and voice type calls, the method comprising: pre-allocating some configured channels to be available for data calls and pre-allocating some said channels to be available for voice calls; receiving at least one command, including information, to provide at least one configured channel for either a voice or a data call; and assigning, based on said information, at least one pre-allocated configured channel in response to said at least one command.

In accordance with an aspect of the present invention there is further provided a method for reducing set-up time for calls, comprising: configuring at least one channel for calls; reserving said at least one configured channel and storing information relating to said at least one configured channel; receiving at least one command, including information, to allocate a channel to a call, and thereafter selecting a configured channel the stored information for which matches said information included in said command; and assigning at least one configured channel to each said call.

In accordance with another aspect of the present invention, there is provided a system for reducing set-up time for calls, comprising: a first agent 130 for configuring and reserving at least one channel; a second agent 140 for supplying communication resources including said configured and reserved channels in response to a communication from said first agent 130, said first agent 130 also being communicative with a principal 120; and a principal 120 that acquires access to configured channels for a call by sending a resource allocation command to said first agent 130 to allocate one of said at least one configured and reserved channel to the call. One embodiment of the present invention uses information respecting the class, location, and status of said resources. Class includes, but is not limited to information about the capacity, direction, type (e.g. data or voice), and programmability of resources. Location includes, but is not limited to information about the IP address, whether a particular resource is on or off-board, and whether or not a high-speed bus may be used to communicate instructions. Status includes, but is not limited to information about whether the resource is available and configured for immediate use. The Principal that is provided access to resources (managed by the first agent and delivered by the second agent) is a BTSC in one embodiment of the present invention, however said method also applies to networks in which the Principal is a submodule of the BTSC (e.g. a Call Resource Manager or “CRM”), the Customer, or any intermediate system(s) serving the End User system.

In accordance with a further aspect of the present invention, there is provided an apparatus being a first agent 130 for a system for reducing set-up time for calls, comprising: a module for configuring at least one channel for calls; a module for reserving and tracking all said configured channels; a module for receiving at least one command to allocate a channel to a call; a module for matching each said command to a configured channel; and a module for allocating a separate configured channel to each said call.

As set out above Query and Splitting 15 identifies and splits the total communication resources available—according to an algorithm that is neither claimed nor disclosed. Further, allocation 30 defines target levels for the portion of configured channels to be reserved. This splitting and allocation functionality are both subject to proactive or reactive change to meet specific needs as well as optimization attempting to better meet the needs of actual or expected loading conditions. In addition to the manual changes implemented during installation and maintenance activities—dynamic changes may be triggered by system operators or automatically. Factors used to alert or trigger manual or dynamic changes include: specific RACs 60, general Quality of Service monitor failures, current loading patterns, and expected loading conditions based on time of day or day of year. Specific factors may trigger RAC 60 queuing and immediate action causing deallocation and reconfiguration of some reserved channels to reactively meet specific demand. General factors may trigger pro-active changes to the splitting algorithm or the reservation target levels of various classes of channel preparing for expected demand.

In one embodiment of the present invention first agent 130 (e.g. a CRP) ascertains information that includes the class, location, and status of available physical resources and the channels to which it thereby has access through second agent 140 (e.g. a CEM or CEM bank). First agent 130 then maintains said information in a database (e.g. a Link List, or Resource Allocation Table) for tracking and reference before principal 120 (e.g. a BTSC, CRM, or other module or apparatus for processing requests from end user devices) sends RAC 60 requesting access to said resources. If the available configured and reserved channels do not exactly match the information with RAC 60, then matching module 50 may: over-allocate the resource (i.e. give an 8× resource when a 4× would have sufficed), downgrade the request (i.e. connect to a smaller capacity channel, thus causing the burst to be set-up at a lower rate than initially requested), or reject the request completely. However, nothing precludes intelligent adjustments to retroactively meet specific needs or proactively prepare to meet expected needs. For example, if an acceptable match for the information with RAC 60 is not immediately found, then RAC 60 may be stored in a queue until fulfillment while first agent 130 causes second agent 140 to deconfigure and release some of its pre-allocated channels for use in configuring new channels with a different class distribution. Such change may solicit operator intervention, be programmed to test other parameters, be programmed to react after a specified tolerance delay, be programmed to react immediately, or may be triggered by a wide range of other programmable conditions. For example, such automatic adjustment sequence could test a parameter reflecting Customer entitlements to priority access based on the nature of data being transferred or enrolment in a priority service plan guaranteeing access time limits. First agent 130 may be programmed to continually attempt to maintain an “appropriate” number of each class of SCH 150 as defined by its (optimal) target level for each class of SCH 150. Similarly, “Quality of Service” related parameters (including, for example, but not in limitation: time to connect, clarity of signal, and call drops) could be used to dynamically influence the active target levels or force a variety of changes. Further, nothing precludes monitoring resource usage levels and dynamically adjusting pre-allocation target levels based on current or statistical loading or traffic patterns rather than original configuration information.

Although the disclosure describes and illustrates various embodiments of the invention, it is to be understood that the invention is not limited to these particular embodiments. Many variations and modifications will now occur to those skilled in the art of resource allocation. For full definition of the scope of the invention, reference is to be made to the appended claims.

We claim:

1. A method for reducing set-up time for calls, comprising:
configuring at least one channel for calls;
reserving said at least one configured channel and storing information relating to said at least one configured channel;
receiving at least one command, including information, to allocate a channel to a call, and thereafter selecting a configured channel the stored information for which matches said information included in said command; and
assigning at least one configured channel to each said call.

2. The method as claimed in claim 1 wherein said step of configuring includes defining the capacity and direction of operation of said channel.

3. The method as claimed in claim 1, each configured channel having a class, location, and status, wherein said step of reserving and tracking includes storing in a separate record of a database, information about the class, location, and status of each configured channel, which record is available for comparison with said at least one command.

4. The method as claimed in claim 1 wherein said step of receiving includes storing said command.

5. The method as claimed in claim 3 wherein said step of matching includes comparing said command with records in said database until a matching record is found.

6. The method as claimed in claim 3 wherein said step of allocating includes providing the location of said configured channel for assignment to said call, and updating the status information of said configured channel stored in the associated record of said database.

7. A system for reducing set-up time for a call, comprising:
a first agent for configuring and reserving at least one channel;
a second agent for supplying communication resources including said configured and reserved channels in response to a communication from said first agent, said first agent also being communicative with a principal; and
said principal adapted to acquire access to configured channels for the call by sending a resource allocation command to said first agent to allocate one of said at least one configured and reserved channel to the call.

8. The system as claimed in claim 7 further wherein said first agent gathers information respecting said communication resources for the purpose of splitting said resources into configured channels.

9. The system as claimed in claim 8 further wherein said information includes the class, location, and status of said resources and said first agent stores said information before it receives allocation commands from said principal.

10. The system as claimed in claim 7 further wherein said first agent can reserve and track configured channels.

11. The system as claimed in claim 7 further wherein said first agent can receive allocation commands, which commands it can match to at least one configured channel.

12. The system as claimed in claim 7 further wherein said first agent can allocate a separate reserved configured channel in response to each allocation command.

13. The system as claimed in claim 7 further wherein said first agent communicates with said principal faster than said principal can communicate with said second agent.

14. The system as claimed in claim 7 further wherein said first agent pre-allocates thereby reserving said configured channels before it receives allocation commands from said principal, further wherein said first agent stores information respecting said pre-allocated configured channels in a database.

15. The system as claimed in claim 7 further wherein said first and second agents may exist at a same location or at different locations.

16. A first agent for a system for reducing set-up time for calls, comprising:
means for configuring at least one channel for said calls;
means for reserving and tracking all said configured channels;
means for receiving at least one command to allocate a channel to a call;
means for matching each said command to a configured channel; and
means for allocating a separate configured channel to each said call.

17. The first agent as claimed in claim 16 further having means for communicating with a second agent supplier of communication resources for accessing said communication resources and querying said second agent respecting physical resources that are available for splitting and configuration into channels.

18. The first agent as claimed in claim 16 further wherein there are means for splitting said physical resources.

19. The first agent as claimed in claim 16 further wherein there are means for configuring channels from said physical resources.

20. The first agent as claimed in claim 16 further wherein there are means for allocating and reserving said configured channels in addition to means for deallocating and releasing said configured channels.

21. The first agent as claimed in claim 16 further having means for recording information respecting said configured channels in a database for tracking in addition to means for updating said database as a result of the allocation or deallocation of configured channels.

22. The first agent as claimed in claim 16 further having means for allocating individual configured channels to said calls and confirming to a principal each said allocation of an individual configured channel.

23. A method for reducing set-up time for calls in a network supporting both data and voice type calls, the method comprising:
pre-allocating some configured channels to be available for data calls and pre-allocating some said channels to be available for voice calls;
receiving at least one command, including information, to provide at least one configured channel for either a voice or a data call; and
assigning, based on said information, at least one pre-allocated configured channel in response to said at least one command.

24. A method for reducing set-up time for calls in a network, the method comprising:
pre-allocating some configured channels to be available for calls;
receiving at least one command, including information, to provide at least one configured channel for a call; and
assigning, based on said information, at least one pre-allocated configured channel in response to said at least one command.
